(19) United States
(12) Patent Application Publication
(10) Pub. No.: US 2013/0169131 A1
(43) Pub. Date: Jul. 4, 2013

(54) ENCLOSURE ASSEMBLY WITH TRAY ASSEMBLY

(71) Applicant: XIU-QUAN HU, Shenzhen City (CN)

(72) Inventor: XIU-QUAN HU, Shenzhen City (CN)

(21) Appl. No.: 13/656,456

(22) Filed: Oct. 19, 2012

(30) Foreign Application Priority Data
Dec. 29, 2011 (CN) 201110450557.1

(51) Int. Cl. F16M 11/00; F16M 13/00

(52) U.S. Cl. 312/265.5; 211/126.3

(57) ABSTRACT

An enclosure assembly includes an enclosure and a tray assembly mounted in the enclosure. The tray assembly includes two trays and a connecting member connected to the two trays. The connecting member includes a base panel and two first securing tabs. The two first securing tabs extend from the base panel along opposite directions. Each of the two first securing tabs defines a first securing hole. Each of the two trays defines a first mounting hole corresponding to the first securing hole. The two trays contact opposite side of the base panel to enable the first securing holes to be aligned with the mounting holes of the two trays.

### BACKGROUND

1. Technical Field

The disclosure generally relates to enclosure assemblies, especially, to an enclosure assembly with a tray assembly.

2. Description of Related Art

A conventional server system includes an enclosure and a plurality of servers mounted in the enclosure. A tray must be mounted in the enclosure to replace a removed server to maintain the stability of the heat dissipation system of the server system. There are two types of enclosures with different sizes. The tray corresponding one type of enclosure cannot be mounted into another type of enclosure.

Thus, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an enclosure assembly.

FIG. 2 is an exploded, isometric view of a tray assembly of FIG. 1.

FIG. 3 is an isometric view of a connecting member of FIG. 2.

FIG. 4 is an assembled view of the enclosure assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

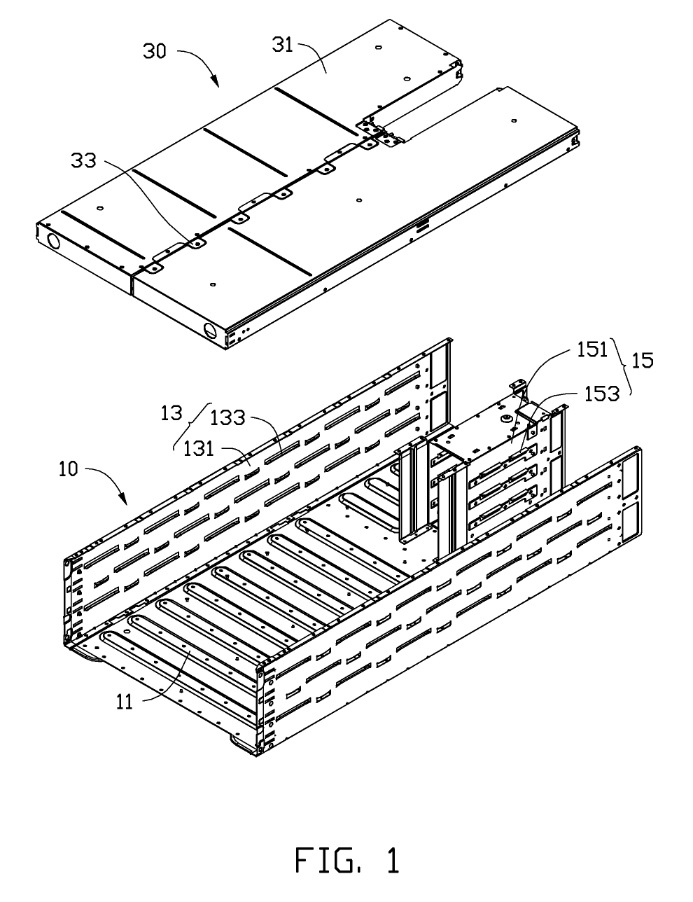

Referring to FIG. 1, one embodiment of an enclosure assembly is shown. The enclosure assembly includes an enclosure 10 and a tray assembly 30 mounted in the enclosure 10.

The enclosure 10 includes a bottom wall 11, two first sidewalls 13 substantially perpendicularly extending from the bottom wall 11, and two second sidewalls 15 substantially perpendicularly extending from the bottom wall 11. The two first sidewalls 13 are substantially parallel to each other. The two second sidewalls 15 are substantially parallel to each other and substantially parallel to the first sidewalls 13. The two second sidewalls 15 are located between the two first sidewalls 13. Each first sidewall 13 includes a first sidewall body 131 and a plurality of first support portions 133, extending from the first sidewall body 131. The first support portions 133 are substantially parallel to each other. Each second sidewall 15 includes a second sidewall body 151 and a plurality of second support portions 153. extending from the second sidewall body 151. The second support portions 153 are substantially parallel to each other.

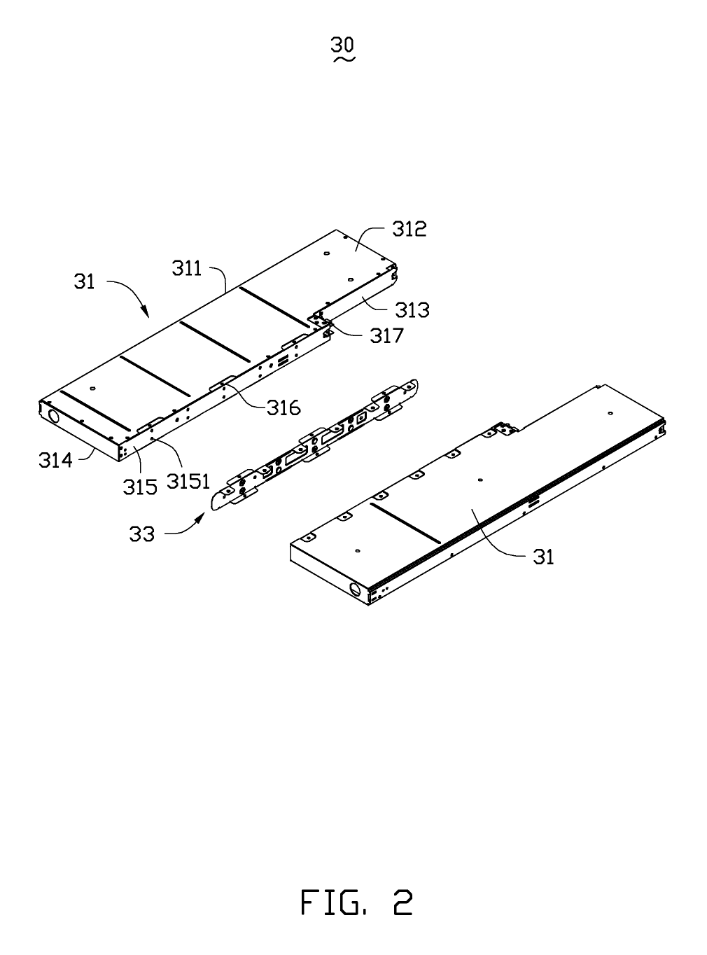

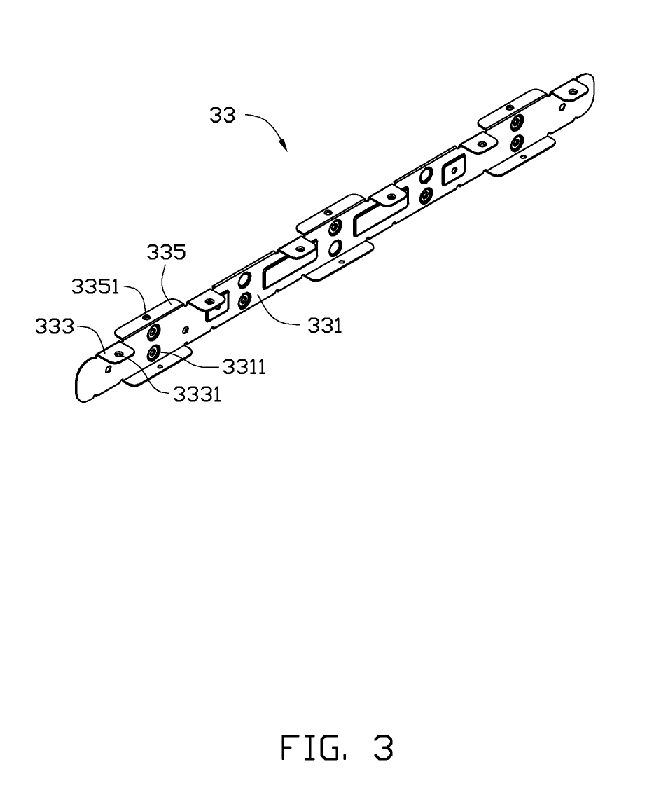

Referring to FIGS. 2 and 3, the tray assembly 30 includes two trays 31 and a connecting member 33.

The tray 31 includes a first side panel 311 substantially parallel to the first sidewall body 131, a second side panel 313, a third side panel 315, and a connecting panel 317, connected to the second panel 313 and the third side panel 315. The first side panel 311, the second side panel 313, and the third side panel 315 are substantially parallel to each other. A distance between the third side panel 315 and the first side panel 311 is greater than a distance between the second side panel 313 and the first side panel 311. The connecting panel 317 is substantially perpendicular to the second side panel 313. The second side panel 313 and the third side panel 315 extend from the connecting panel 317 along opposite directions. A length of the first side panel 311 is substantially equal to the total length of the second side panel 313 and the third side panel 315. The tray 31 further includes an upper panel 312 and a lower panel 314 that is substantially parallel to the upper panel 312. The first side panel 311, the second side panel 313, the third side panel 315, and the connecting panel 317 are connected to the upper panel 312 and the lower panel 314 and substantially perpendicular to the upper panel 312. Each of the upper panel 312 and the lower panel 314 defines a plurality of mounting holes 316. The third side panel 315 defines a plurality of fastening holes 3151.

The connecting member 33 includes a base panel 331, a plurality of pairs of first securing tabs 333 extending from opposite sides of the base panel 331, and a plurality of pairs of second securing tabs 335 extending from opposite sides of the base panel 331. The first securing tabs 333 and the second securing tabs 335 are substantially perpendicular to the base panel 331. Each pair of first securing tabs 33 extends from the base panel 331 along opposite directions. Each pair of second securing tabs 335 extends from the base panel 331 along opposite directions. Each first securing tab 333 defines a first securing hole 331 corresponding to the mounting hole 316. Each second securing tab 335 defines a second securing hole 3351 corresponding to the mounting hole 316. The base panel 331 defines a plurality of through holes 331 corresponding to the fastening holes 3151. The length of the first securing tab 333 is greater than the length of the second securing tabs 335, along a direction substantially perpendicular to the base panel 331.

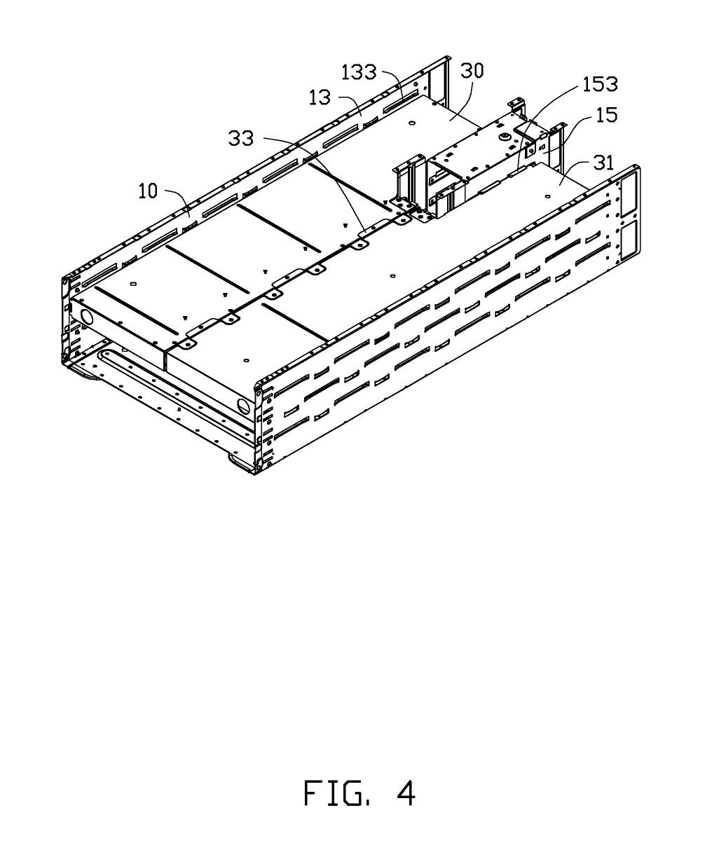

Referring to FIG. 4, in assembly of the tray assembly 30, the through holes 3311 of the connecting member 33 are aligned with the fastening holes 3151 of the third side panel 315 of one tray 31. A plurality of fasteners (not shown) extend through the through holes 3311 to be secured in the fastening holes 3151, thereby securing the connecting member 33 to the third side panel 315. At this time, the first securing holes 3331 and the second securing holes 3351 of the connecting member 33 are aligned with the mounting holes 316 of the tray 31. A plurality of fasteners (not shown) extend through the first securing holes 3331 and the second securing hoes 3351 to be secured in the mounting holes 316. The mounting holes 316 of the other tray 31 are aligned with the first securing holes 3331 and the second securing holes 3351. A plurality of fasteners (not shown) extend through the first securing holes 3331 and the second securing holes 3351, to be secured in the mounting holes 316, thereby securing the other tray 31 to the connecting member 33. The tray assembly 30 is thus assembled.

In assembly of the enclosure assembly, the first side panels 311 of the tray assembly 30 are aligned with the first support portions 133 of the enclosure 10, and the second side panels 313 are aligned with the second support portions 153. The tray assembly 30 moves towards the enclosure 10 to enable the tray assembly 30 to be received in the enclosure 10. At this time, the tray assembly 30 is located on the first support portions 133 and the second support portions 153.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An enclosure assembly, comprising:
an enclosure;
a tray assembly mounted in the enclosure, the tray assembly comprises two trays and a connecting member connected to the two trays; the connecting member comprises a base panel and two first securing tabs; the two first securing tabs extend from the base panel along opposite directions; each of the two first securing tabs defines a first securing hole; each of the two trays defines a first mounting hole corresponding to the first securing hole;
the two trays contact opposite sides of the base panel; and the two first securing holes are aligned with the mounting holes of the two trays.

2. The enclosure assembly of claim 1, wherein the connecting member further comprises two second securing tabs; the two second securing tabs extends from the base panel along opposite directions; each of the two second securing tabs defines a second securing hole; and each of the two trays defines a second mounting hole corresponding to the second securing hole.

3. The enclosure assembly of claim 2, wherein a length of each of the two first securing tabs is greater than a length of each of the two second securing tabs, along a direction substantially perpendicular to the base panel.

4. The enclosure assembly of claim 2, wherein the two second securing tabs are substantially perpendicular to the base panel.

5. The enclosure assembly of claim 1, wherein each of the two trays comprises a first side panel, a second side panel that is substantially parallel to the first side panel, and a connecting panel that is connected to the first side panel and the second side panel; the two first side panels of the two trays contact opposite sides of the base panel; the first side panel and the second side panel extend from the connecting panel along opposite directions; the enclosure comprises two first sidewalls that are substantially parallel to each other, and two second sidewalls that are substantially parallel to each other; the two second sidewalls are substantially parallel to the two first sidewalls and located between the two first sidewalls; and the two second sidewalls are located between the two second side panels.

6. The enclosure assembly of claim 5, wherein each of the two first sidewalls comprises a first support portion that supports the tray assembly, and each of the two second sidewalls comprises a second support portion that supports the tray assembly.

7. The enclosure assembly of claim 1, wherein the two first securing tabs are substantially perpendicular to the base panel.

8. The enclosure assembly of claim 1, wherein the base panel defines a through hole, and one of the two trays defines a fastening hole corresponding to the through hole.

9. A tray assembly, comprising:
a first tray, the first tray defines a first mounting hole;
a second tray; and
a connecting member, the connecting member comprises a base panel and a first securing tab extending from the base panel; the first securing tab defines a first securing hole; the base panel is secured to the second tray to enable the first securing hole to be aligned with the first mounting hole; and the base panel is located between the first tray and the second tray.

10. The tray assembly of claim 9, wherein the base panel defines a through hole; the second tray defines a fastening hole corresponding to the through hole; and a fastener extends through the through hole to be secured in the fastening hole.

11. The tray assembly of claim 9, wherein the connecting member further comprises a second securing tab extending from the base panel; the first securing tab and the second securing tab extend from the base panel along opposite directions; the second securing tab defines a second securing hole; and the second tray defines a second mounting hole corresponding to the second securing hole.

12. The tray assembly of claim 11, wherein the second securing tab is substantially perpendicular to the base panel.

13. The tray assembly of claim 11, wherein a length of the first securing tab is greater than a length of the second securing tab, along a direction substantially perpendicular to the base panel.

14. The tray assembly of claim 9, wherein the first securing tab is substantially perpendicular to the base panel.
